(19) United States
(12) Patent Application Publication
(10) Pub. No.: US 2010/0132810 A1
(43) Pub. Date: Jun. 3, 2010

(54) Adjustable Tub/Shower Valve Mounting Fixture and Method

(76) Inventor: David K. Pompian, Centennial, CO (US)

Correspondence Address: JOHN R LEY, LLC, 5299 DTC BLVD, SUITE 340, GREENWOOD VILLAGE, CO, 80111, US

(21) Appl. No.: 12/629,746

(22) Filed: Dec. 2, 2009

Related U.S. Application Data
(60) Provisional application No. 61/200,751, filed on Dec. 3, 2008.

(51) Int. Cl. F16L 5/00; B23P 17/04

(52) U.S. Cl. 137/356; 29/428

(57) ABSTRACT

A mounting fixture for a shower valve adjustably positions the shower valve in depth and angular orientation with respect to a finished wall surface, even after the shower valve has been plumbed or roughed in.

### CROSS-REFERENCE TO RELATED APPLICATIONS

This application claims the benefit of U.S. Provisional Application No. 61/200,751, filed Dec. 3, 2008.

### FIELD OF THE INVENTION

The present invention relates to adjusting the position of a tub/shower valve mounted within a wall. More particularly, the present invention relates to a new and improved mounting fixture for adjusting both the relative depth and the angular orientation of the shower valve relative to a finished wall surface both before and after the wall has been finished.

### BACKGROUND

Many bathrooms contain bathtubs and/or showers for bathing. Bathtubs and showers typically have a faucet or shower head from which water for bathing is dispensed. Hot and cold water are usually conducted to a mixing valve or tub/shower valve (“shower valve” herein) where the hot and cold water is mixed and then supplied to the faucet and/or shower head. The shower valve typically includes a handle which protrudes from a wall surface within the shower or above the tub. Manipulation of the handle changes the relative proportions of hot and cold water which pass through the shower valve to achieve a desired final temperature of the water supplied to the faucet or shower head.

Shower valves, faucets, shower heads and associated plumbing pipes and hardware are installed during new construction while the walls are framed by metal or studs. The shower valve and associated pipes are mounted between a pair of studs and then soldered or otherwise connected together in a process colloquially referred to as “roughing in.” After the shower valve and associated pipes and hardware have been roughed in, the wall surrounding the shower valve is finished, typically by installing cement board to the studs in preparation for tiling or finishing. Tiling involves applying cement or adhesive to the cement board, and retaining the tile pieces on the cement board and grouting around the tile pieces.

Shower valves are expected to be mounted within a certain predetermined range of acceptable depths from a reference plane or surface of the finished tiled wall. Associated trim pieces as well as the handle for the shower valve are not guaranteed to fit with the shower valve or to operate correctly if the shower valve is at an incorrect depth or angle with respect to the finished tiled wall. The handle attaches to a valve stem of the shower valve and rotates on an axis to control the relative amounts of hot and cold water. The handle and trim pieces may not fit or operate correctly if the axis of the valve stem is not perpendicular to the plane of the finished wall surface.

Since the shower valve is installed before the wall is finished, the location of the finished wall must be estimated. Manufacturers of shower valves usually indicate a reference point or surface (“reference surface” hereafter) on the shower valve which should be flush with, or a predetermined distance or range from the surface of the finished wall. The location of the finished wall surface is estimated as a reference plane. The reference plane is separated from the edges of the studs by a finished wall offset. The finished wall offset is the actual or planned combined thicknesses of the cement board, the tile adhesive and the tiles.

Other construction professionals besides the plumber have an influence on the final fit of the trim pieces and handle to the shower valve. For example, the site foreman or architect may supply the plumber with an estimated finished wall offset that is inaccurate. The estimate is based on the planned thicknesses of the cement board, the thickness of the tile adhesive and the tile pieces. If the originally planned for cement board or tile is used for whatever reason, then substitute cement board and tile must be chosen and installed. If the installed cement board or tile have thicknesses different from the originally anticipated cement board and tile, then the actual finished wall offset will be different from the estimated finished wall offset. Thicker tile is typically heavier than thinner tile and may require more tile cement to secure the tile to the cement board. Thus, substitute tile that is thicker or thinner than the originally planned for tile may cause both the tile and the tile adhesive of the finished wall offset estimate to be inaccurate. The handle and trim pieces may also not fit correctly if the wall contractor or tile installer performs a poor or substandard installation of the cement board and tile.

After the finished wall offset has been estimated, the shower valve is mounted so that the reference surface assumes the desired relationship with the reference plane, and so that the valve stem axis is perpendicular to the reference plane. Typically, the plumber fabricates and mounts a 2″×4″ board (or other support structure) in between a pair of studs, and the shower valve is then rigidly attached to the 2″×4″ board with clamps, screws or other securing devices. It is often difficult to precisely locate the 2″×4″ board to achieve the desired relationship between the reference surface and the reference plane.

Once the shower valve has been mounted to the 2″×4″ board, the pipes are soldered or connected to the shower valve, the wall is finished, and the trim pieces and handle are attached to the shower valve. So long as the estimate of the finished wall offset was accurate and the shower valve was mounted in accordance with the estimate, the trim pieces and handle will fit properly with the shower valve. If the estimated finished wall offset was not accurate, the depth of the shower valve relative to the finished wall surface may have to be changed.

Preferably, a check of the proper fit of the trim pieces and handle to the shower valve is made before the cement board is completely installed and blocks access to the shower valve. So long as the cement board is not blocking the plumber's access to the shower valve, the plumber can typically access the shower valve and attempt to adjust the mounting position of the shower valve to achieve the desired depth of the shower valve from the reference plane. The pipes soldered to the shower valve typically have enough flexibility to allow a small degree of movement of the shower valve towards or away from the reference plane.

Even if the plumber is able to adjust the depth of the shower valve to correct for the error in the estimated finish wall offset, movement of the shower valve from its originally roughed in position may cause the axis of the valve stem to no longer be perpendicular to the finished wall surface. If the valve stem axis deviates too far from being perpendicular to the finished wall surface, the pipes connecting to the shower valve may have to be repositioned, adding significant cost and time to complete the construction. If the finished wall is already completely installed when it is realized that the handle and trim pieces do not fit correctly to the shower valve, then some of the installed cement board will typically have to be removed so that the plumber can adjust the position of the shower valve, which also adds additional costs and time to complete the construction.

### SUMMARY OF THE INVENTION

The present invention facilitates the correct mounting of a shower valve between a pair of studs, facilitates the easy adjustment of both the depth of the shower valve and the angular orientation of the shower valve relative to a reference plane corresponding to a finished wall surface, and permits adjustment even after the wall has been completely finished. The present invention simplifies the installation of the shower valve at the correct depth and angular orientation with respect to the reference plane. Use of the present invention to adjust the depth and angular orientation of the shower valve after the wall has been finished avoids the increased construction costs associated with having to tear down the wall to access and manipulate the position and orientation of the shower valve.

One aspect of the present invention involves a mounting fixture for mounting a shower valve in a wall structure and for permitting adjustment of the depth and angular orientation of the shower valve relative to a finished wall surface. The mounting fixture includes a base unit and a mounting unit. The base unit attaches to the wall structure at a fixed distance and orientation with respect to the finished wall surface. The mounting unit is adapted to retain the shower valve and is connected with the base unit at an adjustable position between the base unit and the finished wall surface. At least one adjustment device is connected between the base unit and the mounting unit. The adjustment device is accessible from the finished wall surface and is operative to move the mounting unit relative to the base unit to adjust the shower valve in depth and angular orientation relative to the finished wall surface.

Another aspect of the present invention relates to a method of mounting a shower valve in a wall structure and permitting adjustment of the depth and angular orientation of the shower valve relative to a finished wall surface of the wall structure. The method involves attaching the shower valve to a mounting unit; adjusting the mounting unit with the attached shower valve in depth and angular orientation relative to the finished wall surface to adjust the position of the shower valve relative to the finished wall surface; and accomplishing the adjustment of the mounting unit from the exterior of the finished wall within an opening formed in the finished wall surrounding the shower valve.

Other aspects of the present invention involve alignment devices which confine the movement of the mounting unit relative to the base unit to a depth dimension; an extension arm connected to the base unit and extending to the wall structure for selectively laterally positioning the location of each alignment device; and a retention device connected between the extension arm and the base unit for retaining the extension arm in a preestablished position relative to the base unit.

Still additional aspects of the present invention include adjusting the distance between the base and mounting units from the initial distance after the finished wall has been attached to the wall structure; selectively retaining the lateral location of the mounting unit within the wall structure prior to connecting the finished wall to the wall structure; and adjusting the angular orientation between the base unit and the mounting unit after the finished wall has been attached to the wall structure.

Other aspects of the present invention, and a more complete appreciation of the present invention, as well as the manner in which the present invention achieves the above and other improvements, can be obtained by reference to the following detailed description of a presently preferred embodiment taken in conjunction with the accompanying drawings, which are briefly summarized below, and by reference to the appended claims.

### BRIEF DESCRIPTION OF THE DRAWINGS

FIG. 1 is a perspective view of a mounting fixture which incorporates the present invention, shown mounted between a pair of studs and supporting a shower valve which is connected to water pipes.

FIG. 2 is an exploded perspective view of the mounting fixture shown in FIG. 1.

FIG. 3 is an enlarged perspective view of the mounting fixture and shower valve shown in FIG. 1 with a broken away portion showing a base plate of the mounting fixture.

FIG. 4 is an elevational view of the mounting fixture and shower valve shown in FIG. 1 installed between studs to which is attached a relatively thin wall.

FIG. 5 is an elevational view of the mounting fixture and shower valve similar to FIG. 1 installed relative to a thick wall.

FIG. 6 is a plan view of the shower valve and a portion of a surrounding finished wall which shows depth adjustment screws accessible through access openings in a backing plate of the shower valve.

FIG. 7 is an elevational view of the mounting fixture and shower valve shown in FIG. 1 inaccurately positioned so that a reference surface associated with the shower valve is not parallel to the finished wall surface.

### DETAILED DESCRIPTION

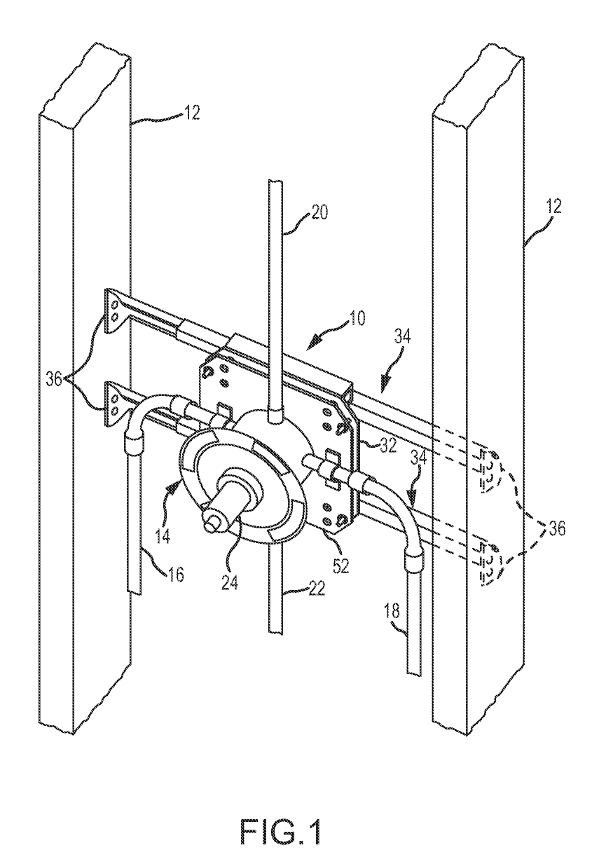

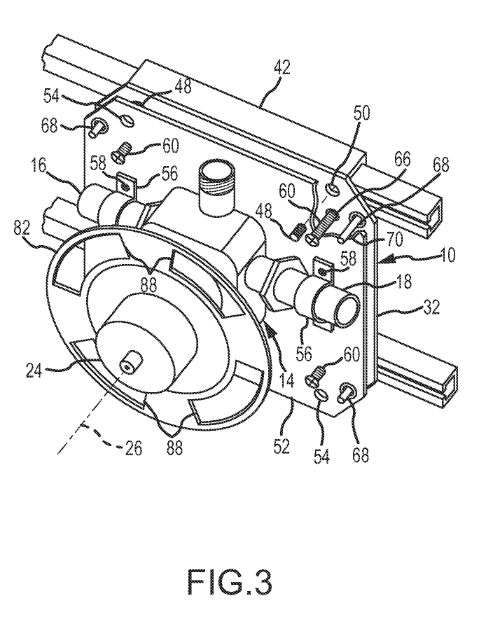

A shower valve mounting fixture (“mounting fixture” hereafter) 10 which incorporates the present invention is shown in FIG. 1. The mounting fixture 10 is positioned between and attached to a pair of studs 12. The mounting fixture 10 supports a shower valve 14 on a front side of the mounting fixture 10. The shower valve 14 is shown connected to hot and cold water pipes 16 and 18, respectively and shower head and faucet pipes 20 and 22, respectively. A valve stem 24 protrudes from the shower valve 14 and connects to a handle (not shown) which is used to rotate the valve stem 24 about an axis 26 (FIG. 3) of the valve stem 24. Rotation of the valve stem 24 determines the relative proportions of hot and cold water that is supplied from the pipes 16 and 18 to either the shower head or faucet pipes 20 and 22.

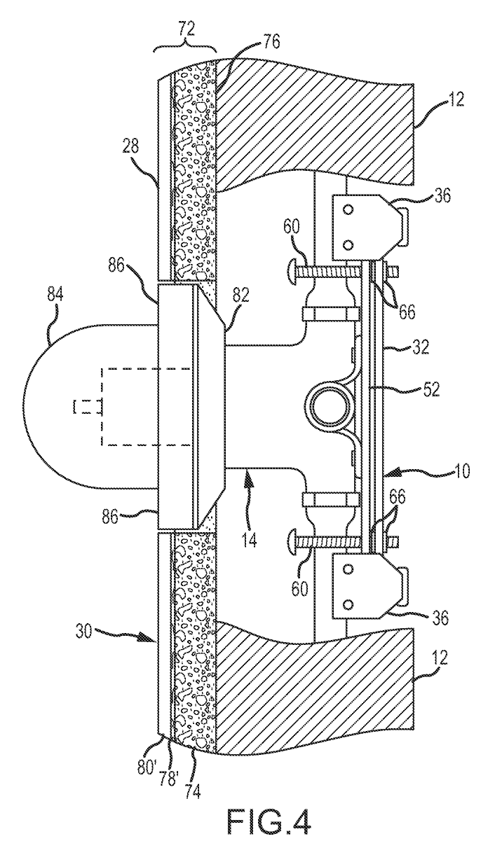

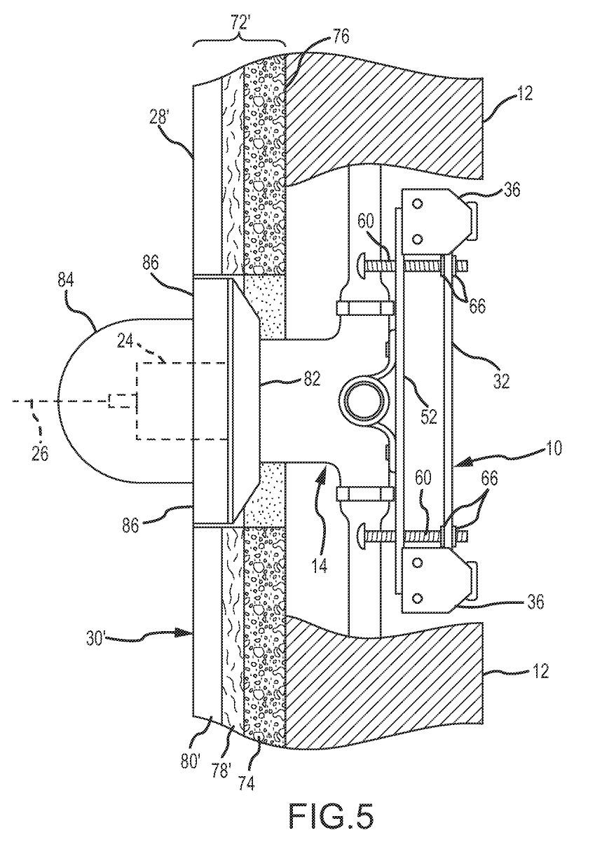

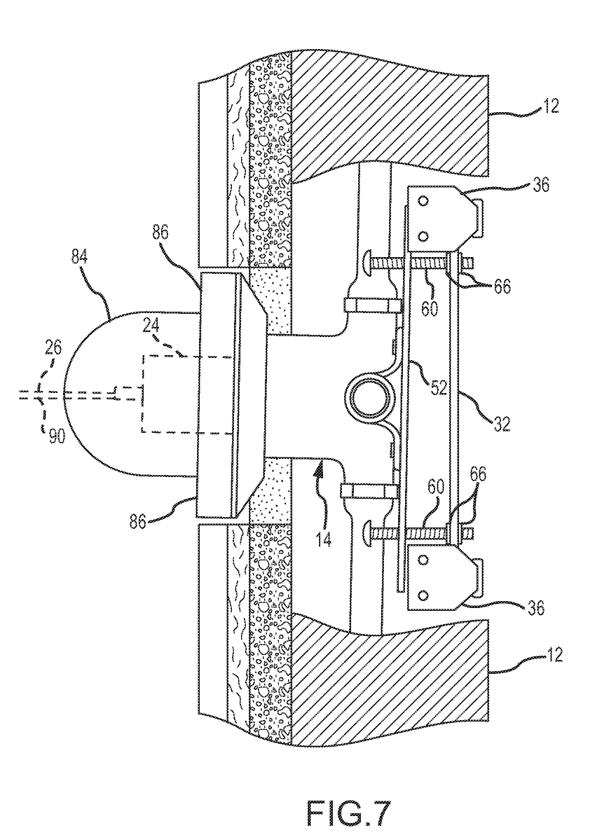

The mounting fixture 10 allows for the precise positioning of the shower valve 14, both before and after “roughing in” the shower valve 14. The mounting fixture 10 is secured to the studs 12 to position the shower valve 14 in an initial mounting position from which the pipes 16, 18, 20 and 22 are soldered or connected to the shower valve 14, thus roughing in the shower valve 14. The initial mounting position of the shower valve 14 is between the studs 12 and adjusted to locate the shower valve above the bathtub or in the shower tub. The initial mounting position of the shower valve 14 may also be established at a selected depth between the studs 12 relative to a wall surface 28 (FIGS. 4 and 5) of a wall 30 (FIGS. 4 and 5) which is later attached to the studs 12. After the shower valve 14 has been roughed in, the mounting fixture 10 may be adjusted to change both the depth of the shower valve 14 relative to the wall surface 28 (FIGS. 4-6) and the angular orientation of the shower valve 14 and the valve stem axis 26 relative to the finished wall surface (FIG. 7). Furthermore, the adjustment of the relative depth and angular orientation of the shower valve 14 may be performed after the wall 30 has been finished, when the mounting fixture 10 is used in conjunction with certain shower valves 14. The relative depth and angular orientation of the shower valve 14 is adjusted after the wall 30 has been finished to correct for errors in the initial alignment of the shower valve 14, errors in the estimated finished wall offset or substandard installation of the finished wall. The relative depth and angular orientation adjustments of the shower valve 14 are accomplished without having to tear down the finished wall to access the shower valve 14 or mounting fixture 10. The innovative features of the mounting fixture 10 which allow the shower valve 14 to be positioned as desired are described below.

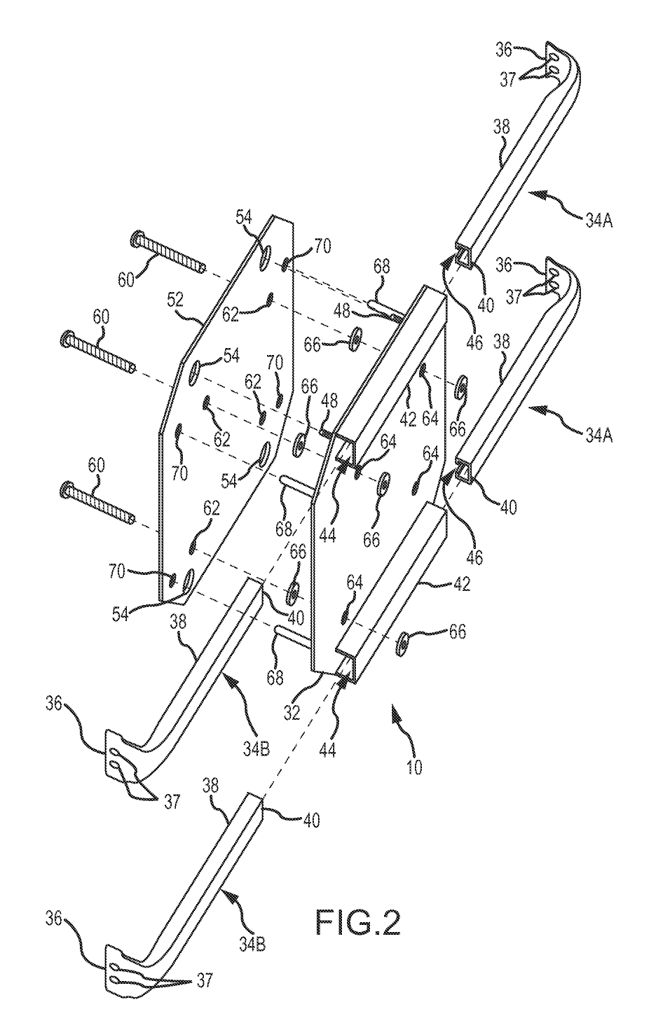

The mounting fixture 10 includes a base plate 32 which is movably connected to two pairs of extension arms 34. The extension arms 34 are positioned on a back side of the base plate 32 along top and bottom sides of the base plate 32, which is preferably generally square shaped. Each of the arms 34 includes a pair of bracket ends 36 which are secured to inward facing sides of the two studs 12. The base plate 32 slides over the extension arms 34 so that the shower valve 14 can be positioned closer to one of the studs 12 or the other as desired. Each of the extension arms 34 includes a receiver portion 34A and an insert portion 34B, as better shown in FIG. 2. Both portions 34A and 34B have a straight narrow section 38 having a generally rectangularly shaped cross-section which starts from a connection end 40 of the portions 34A and 34B and which extends to the bracket ends 36 of the portions 34A and 34B. The bracket ends 36 include holes 37 through which nails or screws are inserted in order to secure the bracket ends 36 to the studs 12. C-shaped channels 42 are attached to the back side of the base plate 32 along the top and bottom sides of the base plate 32 as shown in FIG. 2. The C-shaped channels 42 and the base plate 32 define passageways 44 in which the portions 34A and 34B are positioned and move relative to the base plate 32.

The connection ends 40 of the receiver portions 34A define openings 46 through which the connection ends 40 of the insert portions 34B are slidably inserted. The distance between the bracket ends 36 of either of the extension arms 34 may be changed by inserting the insert portions 34B into the receiver portions 34A to a greater or lesser degree to accommodate mounting the mounting fixture 10 between studs 12 spaced apart by different distances.

Once the bracket ends 36 have been spaced apart by a desired distance and the base plate 32 has been positioned relative to the extension arms 34 at a desired location, set screws 48 are tightened to prevent the extension arms 34 from moving relative to the base plate 32 and the rest of the mounting fixture 10, as shown in FIGS. 2 and 3. Each set screw 48 is threaded into a corresponding threaded opening 50 (FIG. 3) in the base plate 32 so that each set screw 48 contacts one of the portions 34A or 34B and thereafter retains the contacted portion 34A or 34B from moving relative to the base plate 32.

A mounting plate 52 is connected to move relative to the base plate 32 on a front side of the base plate 32. The mounting plate 52 has the same general shape as the base plate 32. Each of four access openings 54 formed in the mounting plate 52 are positioned adjacent to one of the set screws 48. The set screws 48 are tightened or loosened by inserting a tool, such as a screwdriver, through the access openings 54 to engage the set screws 48. A pair of pipe clamps 56 secures the shower valve 14 to the mounting plate 52 by securing the hot and cold pipes 16 and 18 to the mounting plate 52, as shown in FIG. 3. Each of the pipe clamps 56 is rigidly connected to the mounting plate 52 by a pair of screws 58 which are threaded into the mounting plate 52. Once the shower valve 14 has been secured to the mounting plate 52 by the pipe clamps 56, the shower valve 14 maintains a fixed position relative to the mounting plate 52.

Four depth adjustment screws 60 are spaced close to each of four corners of the generally square shaped mounting plate 52. Rotation of the depth adjustment screws 60 changes both the distance between the mounting and base plates 52 and 32 (FIGS. 4 and 5) as well as the angular orientation between the mounting and base plates 52 and 32 (FIG. 7). The mounting plate 52 has threaded openings 62 which mate with the threads of the depth adjustment screws 60, as shown in FIG. 2. Back ends of the depth adjustment screws 60 pass through free rotation holes 64 formed in the base plate 32. The free rotation holes 64 have a diameter that is larger than the diameter of the depth adjustment screws 60 so that the depth adjustment screws 60 rotate freely within the free rotation holes 64. A pair of shoulder washers 66 are attached to the rear ends of each depth adjustment screw 60 on both the rear and front sides of the base plate 32. The shoulder washers 66 secure the depth adjustment screws 60 relative to the base plate 32 without inhibiting the rotation of the depth adjustment screws 60. The shoulder washers 66 are maintained at a fixed position on the depth adjustment screws 60 even when the depth adjustment screws 60 are rotated.

Four alignment posts 68 are rigidly connected to the base plate 32 and extend perpendicularly towards the mounting plate 52 from the base plate 32 near one of the four corners of the base plate 32. The alignment posts 68 pass through post holes 70 formed in the mounting plate 52, each of which are positioned to correspond in location to one of the alignment posts 68. The alignment posts 68 and post holes 70 prevent the mounting plate 52 from rotating relative to the base plate 32 about an axis perpendicular to the base plate 32. The combination of the alignment posts 68 and the post holes 70 relieves stress from the depth adjustment screws 60 which might otherwise cause the depth adjustment screws 60 to deviate from being substantially perpendicular to the base plate 32 if the mounting plate 52 were to rotate relative to the base plate 32.

The depth adjustability of the mounting fixture 10 is further described below with reference to FIGS. 4 and 5. The wall 30 shown in FIG. 4 has a thickness or finished wall offset 72 which is less than the thickness or finished wall offset 72′ of the wall 30′ shown in FIG. 5. Both walls 30 and 30′ include cement board 74 which is secured to an edge 76 of the studs 12. The wall 30 includes a relatively thin layer of tile adhesive or cement 78 which secures relatively thin tiles 80 to the cement board 74. The wall 30′ includes a relatively thick layer of tile adhesive or cement 78′ which secures relatively thick tiles 80′ to the cement board 74.

The shower valve 14 includes a backing plate 82 to which a plaster guard 84 is temporarily attached. The plaster guard 84 provides a reference surface 86 which must be flush with the surface 28 or 28′ of the walls 30 or 30′ in order for the handle and trim pieces (not otherwise shown) to fit and operate properly with the shower valve 14. Even though the walls 30 and 30′ have different offsets 72 and 72′ and the bracket ends 36 are mounted at the same locations relative to the studs 12, the mounting fixture 10 allows the depth of the shower valve 14 to be adjusted so that the reference surface 86 is flush with the wall surfaces 28 and 28′. The relative depth of the shower valve 14 is changed by screwing or rotating the depth adjustment screws 60 to move the mounting plate 52 relative to the base plate 32.

In the situation where the finished wall offset 72/72′ cannot be precisely estimated before the wall 30/30′ is constructed, the depth of the shower valve 14 can be adjusted after the mounting fixture 10 has been installed between the studs 12 to account for variances in the finished wall offset and thus achieve the desired relationship of the shower valve 14 between the reference surface 86 and the wall surface 28/28′.

The initial amount of separation between the mounting plate 52 and the base plate 32 when the mounting fixture 10 is installed should be chosen with consideration of the probability that the actual finished wall offset will be either greater or less than the estimated finished wall offset. For example, if the actual finished wall offset might be greater or less than the estimated finished wall offset, then the mounting plate 52 should be spaced initially from the base plate 32 about half of the maximum separation between the plates 32 and 52. This initial separation between the plates 52 and 32 affords the opportunity to either increase or decrease the depth of the shower valve 14 after the shower valve 14 has been roughed in and the wall constructed. As another example, if the estimated finished wall offset is known to represent the smallest likely value of the actual finished wall offset, then the mounting plate 52 is preferably initially spaced as close as possible to the base plate 32. If the actual finished wall offset is then discovered to be greater than the estimated finished wall offset after the mounting fixture 10 has been installed, the mounting plate 52 can be adjusted farther away from the base plate 32 to achieve the desired relationship between the reference surface 86 and the wall surface 28/28′.

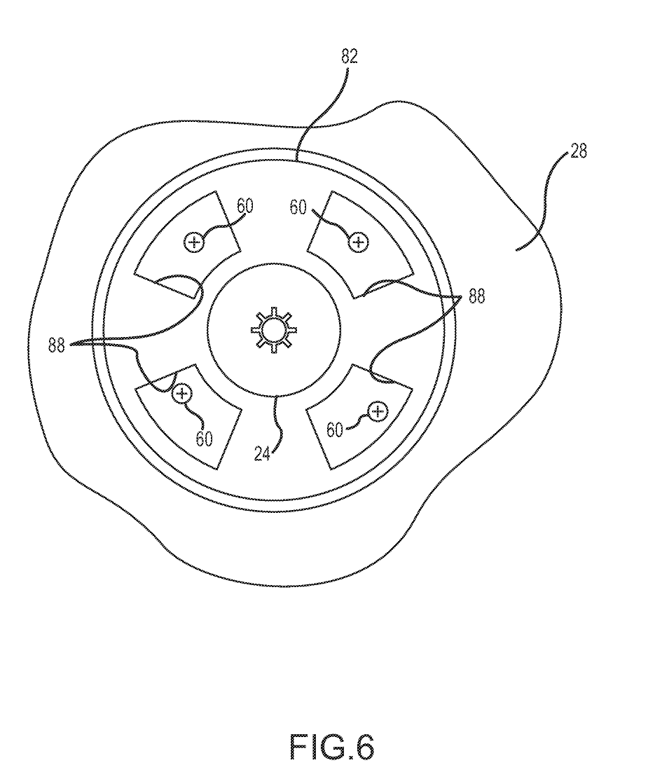

The depth adjustment screws 60 are preferably accessible and adjustable even after the wall 30/30′ has been constructed. Some models of shower valves, such as the shower valve 14 (FIGS. 1 and 3-7), have backing plate access openings 88 (FIGS. 3 and 6) in the backing plate 82 through which a tool, such as a screwdriver, can be inserted to reach the depth adjustment screws 60. When used in conjunction with such shower valves 14, the depth adjustment screws 60 can be positioned in the mounting fixture 10 so that they can be easily accessed through the openings 88, as shown in FIG. 6. The capability to adjust the depth of the shower valve 14 after the wall 30/30′ has been constructed is a significant advantage of the mounting fixture 10 versus other shower valve mounting devices because it avoids the necessity to tear down a portion of the wall 30/30′ to access the shower valve 14. If the depth of the shower valve 14 needs to be adjusted after the wall 30/30′ has been constructed, for instance because the estimated finished wall offset was inaccurate, then the depth adjustment screws 60 are easily accessed and turned through the openings 88 to achieve the proper depth of the shower valve 14.

The mounting fixture 10 is preferably initially installed between the studs 12 so that the reference surface 86 is flush with the reference plane corresponding to the planned location of the wall surface 28/28′ and the valve stem axis 26 is perpendicular to the reference plane. Even if the shower valve 14 is roughed in with the reference surface 86 flush with the reference plane, later adjustment of the depth of the shower valve 14 may cause the reference surface 86 to deviate from parallel to the reference plane.

The shower valve 14 shown in FIG. 7 has a reference surface 86 that is deviated from being parallel to the finished wall surface 28′. This deviation could result from either the depth of the shower valve 14 having been previously adjusted or as a result of an inaccurate initial mounting position of the mounting fixture 10 and shower valve 14. Just as the pipes 16, 18, 20 and 22 have enough length to allow for sufficient depth adjustments of the shower valve 14 after the shower valve 14 has been roughed in, the pipes 16, 18, 20 and 22 typically have enough play in them to allow the shower valve 14 to be slightly tilted or rotated in an up and down or side to side direction. As shown in FIG. 7, the deviation of the reference surface 86 has resulted in the bottom most portion of the reference surface 86 protruding beyond the wall surface 28′ and the top most portion of the reference surface 86 depressed from the wall surface 28′. To correct the deviation of the reference surface 86 as shown in FIG. 7, the top most depth adjustment screws 60 are turned to increase the distance between the top portions of the mounting and base plates 52 and 32, and the bottom most depth adjustment screws 60 are turned to decrease the distance between the bottom portions of the mounting and base plates 52 and 32. After these adjustments are made, the reference surface 86 is made parallel to the wall surface 28′ as shown in FIG. 5. Similar adjustments to the angular orientation of the shower valve 14 are made by adjustment of the depth adjustment screws 60 to make the reference surface 86 parallel to the finished wall surface 28′ when any portion of the reference surface 86 is depressed behind or protrudes in front of the finished wall surface 28′.

The components of the mounting fixture 10 are preferably constructed of galvanized steel, reinforced plastic or other material that is suitably rigid to support the shower valve 14 and to adjust the depth of the shower valve 14 after the shower valve 14 has been roughed in; and which resists corrosion in a moisture laden environment. Other embodiments of the present invention may involve the mounting plate 32 being secured directly to a sturdy support erected between a pair of studs rather than using the extension arms to support the mounting fixture 14 between the studs. For example, the base plate could be directly connected to a 2″×4″ board which is supported between a pair of studs. This alternate embodiment would not require the extension arms.

The present invention offers a number of significant advantages over previously known shower valve mounting devices or techniques. The present invention facilitates the initial mounting of the shower valve at a desired location between a pair of studs prior to roughing in the shower valve. The present invention allows the depth of the shower valve to be easily adjusted after the shower valve has been roughed in and even after the wall attached to the studs is finished. The present invention also allows the angular orientation of the shower valve to be adjusted after the shower valve has been roughed in. The versatility and adjustability of the present invention saves costs during construction by avoiding having to remount the shower valve after its is discovered that the depth or angular orientation of the shower valve needs to be changed.

A presently preferred embodiment of the present invention and many of its improvements have been described with a degree of particularity. This description is a preferred example of implementing the present invention, and is not necessarily intended to limit the scope of the invention. The scope of the invention is defined by the following claims.

What is claimed:

1. A mounting fixture for mounting a shower valve in a wall structure and for permitting adjustment of the depth and angular orientation of the shower valve relative to a finished wall surface connected to the wall structure, comprising:
a base unit adapted to be attached to the wall structure at a fixed distance and orientation from the finished wall surface;
a mounting unit connected with the base unit at an adjustable position between the base unit and the finished wall surface, the mounting unit adapted to retain the shower valve; and
at least one adjustment device connected between the base unit and the mounting unit and accessible from the exterior of the finished wall surface and operative to move the mounting unit relative to the base unit to adjust the shower valve in depth and angular orientation relative to the finished wall surface.

2. A mounting fixture as defined in claim 1, further comprising:
a plurality of the adjustment devices connected between the base unit and the mounting unit at a plurality of separated locations to establish a selectable distance between the mounting unit and the base unit at the location of each adjustment device.

3. A mounting fixture as defined in claim 2, wherein:
each of the adjustment devices is accessible to establish the selectable distance at a location adjacent to the shower valve and within an opening formed in the finished wall surrounding the shower valve.

4. A mounting fixture as defined in claim 2, further comprising:
a plurality of alignment devices connected to confine the mounting unit to move in a depth dimension relative to the base unit at the location of each alignment device.

5. A mounting fixture as defined in claim 2, wherein:
each of the depth adjustment devices has a threaded elongate body which spins about a longitudinal axis to establish the selective distance between the base and mounting units; and
each of the depth adjustment devices remains in the same general longitudinal position with respect to one of the base and mounting units as the selectable distance between the base and mounting units is varied.

6. A mounting fixture as defined in claim 5, wherein each of the depth adjustment screws includes a locating protrusion which contacts the one of the base and mounting units to maintain the same general longitudinal position of the depth adjustment device with respect to the one of the base and mounting units.

7. A mounting fixture as defined in claim 1, further comprising:
at least one extension arm connected to the base unit and extending to the wall structure for selectively laterally positioning the location of the base and mounting units in the wall structure.

8. A mounting fixture as defined in claim 7, further comprising:
a retention device connected between the extension arm and the base unit for retaining each extension arm in a preestablished position relative to the base unit.

9. A mounting fixture as defined in claim 8, wherein the wall structure comprises a pair of studs, and the extension arm comprises:
first and second portions, each of the first and second portions having mounting points for connection to one of the pair of studs, the first and second portions being slidably connected to one another to vary the distance between the mounting points to accommodate mounting the extension arm to pairs of studs separated by different distances.

10. A mounting fixture as defined in claim 8, where the mounting unit comprises:
an access opening formed in the mounting unit to allow access to the retention device from the finished wall surface.

11. A method of mounting a shower valve in a wall structure and permitting adjustment of the depth and angular orientation of the shower valve relative to a finished wall surface connected to the wall structure, comprising:
attaching the shower valve to a mounting unit;
adjusting the mounting unit with the attached shower valve in depth and angular orientation relative to the finished wall surface to adjust the position of the shower valve relative to the finished wall surface; and
accomplishing the adjustment of the mounting unit from the exterior of the finished wall within an opening formed in the finished wall surrounding the shower valve.

12. A method as defined in claim 11, further comprising:
selectively retaining the lateral location of the mounting unit within the wall structure prior to connecting the finished wall to the wall structure.

13. A method of mounting and adjusting the position of a shower valve between a pair of studs using a mounting fixture having a mounting unit selectively movable with respect to a base unit, the shower valve including a reference surface for alignment with a surface of a finished wall which attaches to the studs, comprising:
rigidly attaching the shower valve to the mounting unit;
rigidly attaching the base unit of the mounting fixture to the pair of studs;
establishing a reference plane where the finished wall surface is intended to be located prior to attachment of the finished wall to the studs; and
establishing an initial distance between the base and mounting units so that the reference surface is flush with the reference plane.

14. A method as defined in claim 13, further comprising:
roughing in the shower valve;
adjusting the distance between the base and mounting units from the initial distance between the base and mounting units after the shower valve has been roughed in.

15. A method as defined in claim 14, further comprising:
adjusting the distance between the base and mounting units from the established initial distance between the base and mounting units after the wall has been attached to the studs.

16. A method as defined in claim 15, further comprising:
adjusting the distance between the base and mounting units by movement of a plurality of depth adjustment devices connected to both the base and mounting units.

17. A method as defined in claim 16, further comprising:
adjusting the angular orientation of the shower valve relative to the reference plane to make the reference surface flush with the reference plane by adjusting the angular orientation between the mounting unit and the base unit.

18. A method as defined in claim 17, further comprising:
adjusting the angular orientation between the mounting unit and the base unit by movement of some of the plurality of depth adjustment devices connected to both the mounting unit and the base unit and which is accessible directly from the reference plane.

19. A method as defined in claim 13, further comprising:
confining the movement of the mounting unit with respect to the base unit to a depth dimension.

20. A method as defined in claim 13, further comprising:
selectively laterally locating the base unit closer to one of the studs or the other prior to rigidly attaching the base unit to the studs.
